(19) United States
(12) Patent Application Publication
(10) Pub. No.: US 2005/0110746 A1
(43) Pub. Date: May 26, 2005

(54) Power-saving method for an optical navigation device

(76) Inventor: Alpha Hou, San Jose, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/720,243

(22) Filed: Nov. 25, 2003

(51) Int. Cl. G09G 5/00

(52) U.S. Cl. 345/156; 345/164; 345/163; 345/162; 345/166; 345/167; 345/158

(57) ABSTRACT

A power-saving method for an optical navigation device is proposed, wherein the image capture frame rate of a sensor is controlled according to the moving speed of the optical navigation device. The image capture frame rate is determined based on the variations of a horizontal displacement and a vertical displacement of the optical navigation device for saving power. Moreover, when the optical navigation device is in the sleeping mode, it is not necessary to generate a current to drive the sensor to monitor whether the optical navigation device moves or not. A displacement detector (e.g., a mechanical displacement trigger) is used instead to generate a current for breaking off the sleeping mode to accomplish the power-saving object.

### FIELD OF THE INVENTION

The present invention relates to a power-saving method for an optical navigation device and, more particularly, to a power-saving method, which controls the image capture frame rate of a sensor and makes use of a motion detector like a mechanical motion trigger to wake up the optical navigation device from the sleeping mode.

### BACKGROUND OF THE INVENTION

Along with continual popularity of computers, the demand for the quality of peripherals thereof increases gradually. The mouse is an inevitable peripheral of computer. Because of the high accuracy of motion of optical navigation devices, they have been widely used in this industry. An optical navigation device captures consecutive images in the known time interval from the captured image frame rate to calculate the movement and determine a horizontal displacement of a parallel axis (x-axis) and a vertical displacement of a vertical axis (y-axis) of this optical navigation device and then outputs the displacements data to a computer.

As shown in FIG. 1, the operation of a conventional optical navigation device comprises the following steps:
Step S1: The image sensor is used to capture a first image;
Step S2: The image sensor is used to capture a second image;
Step S3: A digital signal processor is used to compare the first and second images and calculate the movement;
Step S4: A horizontal displacement Δx of the x-axis and a vertical displacement Δy of the y-axis are generated;
Step S5: The horizontal displacement Δx and the vertical displacement Δy are outputted in a fixed output period.

The shorter the time for capturing the consecutive first and second images in Steps S1 and S2 is, the faster moving speed can be detected, and the shorter exposure time of the image sensor can be used. Therefore, a larger power is required to drive the LED light source and the processor. On the contrary, the slower the motion, the more power-saving. This period of time is the image capture frame rate. In other words, the higher the capture frame rate, the more power consuming. In Step S3, when the first image equals to the second image, the horizontal displacement and the vertical displacement are zeros, i.e., there is no motion. If there is no motion detected after a specific time, a power-saving mode is entered. The power-saving mode of the optical navigation device mainly comprises the steps of:
Step S30: A first waiting period is lasted;
Step S31: A second waiting period is lasted;
Step S32: An intermittent mode is entered;
Step S34: A sleeping mode is entered.

In Step S30, the sensor will still capture images to detect the displacement of the mouse in the first waiting period. If the optical navigation device is still in the static state after the first waiting period, the second waiting period is entered. Meanwhile, the sensor will stop for a period of time to save power after work is finished each time. In Step 31, the sensor will still capture images for comparison after stopping for a period of time. If the mouse is still in the static state after the second waiting period, the sleeping mode is entered. When entering the sleeping mode, the sensor will stop for a longer time to save power. After this fixed time, the sensor will capture images to make sure whether the optical navigation device moves or not (S32). On the contrary, the optical navigation device will enter the intermittent mode. Meanwhile, the sensor will capture images to make sure whether the optical navigation device moves or not (S34) after a fixed time. The fixed time of the intermittent mode is shorter than the fixed time of the sleeping mode.

Therefore, the conventional optical navigation device only enters the power-saving mode when it doesn't move at all. However, no matter it is in the intermittent mode or the sleeping mode, a current will be generated after a fixed time to drive the sensor to capture an image. The longer this fixed time, the more power-saving, and the more difficult it will be awaken to monitor whether the optical navigation device moves or not. Although an intermittent time is used to control the sensor to capture an image, the optical navigation device is still very power-consuming. Due to gradual maturity of the Bluetooth technology, the control in current becomes more important for lengthening the usable time of a wireless optical position device.

Accordingly, the present invention aims to propose a novel power-saving method for an optical navigation device to solve the above problems in the prior art.

### SUMMARY OF THE INVENTION

The primary object of the present invention is to provide a power-saving method for an optical navigation device, wherein the image capture frame rate of a sensor is controlled according to the variations of a horizontal and a vertical moving speed through comparison of images. When the variations of the horizontal displacement Δx and the vertical displacement Δy are smaller than a lower threshold, the image capture frame rate of the sensor is decreased. When the variations of the horizontal displacement Δx and the vertical displacement Δy are larger than an upper threshold, the image capture frame rate of the sensor is increased. The image capture frame rate of the sensor is controlled according to the moving speed of the optical navigation device instead of fixing the image capture frame rate of the sensor, hence accomplishing the power-saving object.

Another object of the present invention is to provide a power-saving method for an optical navigation device, wherein a motion detector (e.g., a mechanical motion trigger) is used to generate an interrupt signal to wake up this device from the sleeping mode. Moreover, it is not necessary to generate any current for driving the sensor to detect whether the optical navigation device moves or not during the sleeping mode. The displacement detector can be used to generate an interrupt signal to wake up this device from the sleeping mode to drive the sensor to capture images.

To achieve the above objects, in the power-saving method for an optical navigation device of the present invention, the image capture frame rate of the sensor is controlled according to the moving speed of the optical navigation device. The image capture frame rate is determined based on the variations of a horizontal displacement and a vertical displacement of the optical navigation device. Because a user usually moves the optical navigation device slowly, the power of the optical navigation device can be saved. Moreover, it is not necessary to generate a current to drive the sensor to detect whether the optical navigation device moves or not when the optical navigation device is in the sleeping mode. A displacement detector can be used to generate a interrupt signal to wake up this device from the sleeping mode to accomplish the power-saving object.

The various objects and advantages of the present invention will be more readily understood from the following detailed description when read in conjunction with the appended drawing, in which:

### BRIEF DESCRIPTION OF THE DRAWINGS

FIG. 1 is a flowchart of an optical navigation device in the prior art;

FIG. 2 is a flowchart of a power-saving method for an optical navigation device according to a preferred embodiment of the present invention;

FIG. 3 is a flowchart of a power-saving method for an optical navigation device during the sleeping mode according to a preferred embodiment of the present invention;

FIG. 4A is a diagram of a mechanical structure for interrupting the sleeping mode according to a preferred embodiment of the present invention;

FIG. 4B is another diagram of the mechanical structure in FIG. 4A for interrupting the sleeping mode according to the preferred embodiment of the present invention;

FIG. 4C is a diagram of another mechanical structure for interrupting the sleeping mode according to another preferred embodiment of the present invention;

FIG. 4D is a diagram of another mechanical structure for interrupting the sleeping mode according to a preferred embodiment of the present invention; and

FIG. 4E is a diagram of yet another mechanical structure for interrupting the sleeping mode according to a preferred embodiment of the present invention.

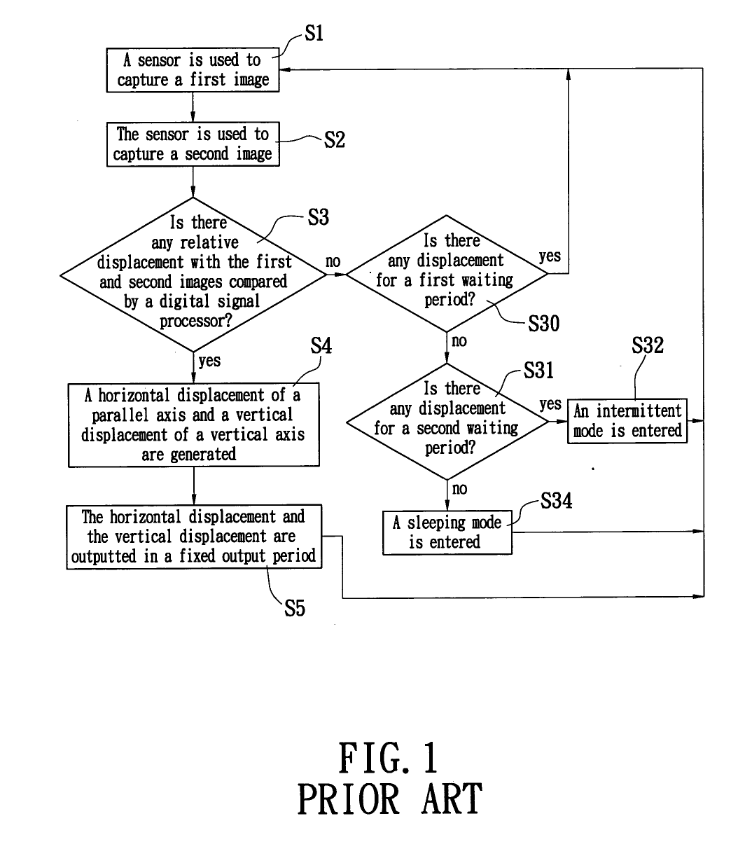

### DETAILED DESCRIPTION OF THE PREFERRED EMBODIMENTS

The present invention aims to solve the problem of large power consumption of a conventional optical navigation device. The moving speed of the optical navigation device is exploited to control the image capture frame rate of a sensor. In the prior art, the image capture frame rate of the optical navigation device is a fixed value. Regard of the moving speed, the same image capture frame rate is kept to accomplish the power-saving object.

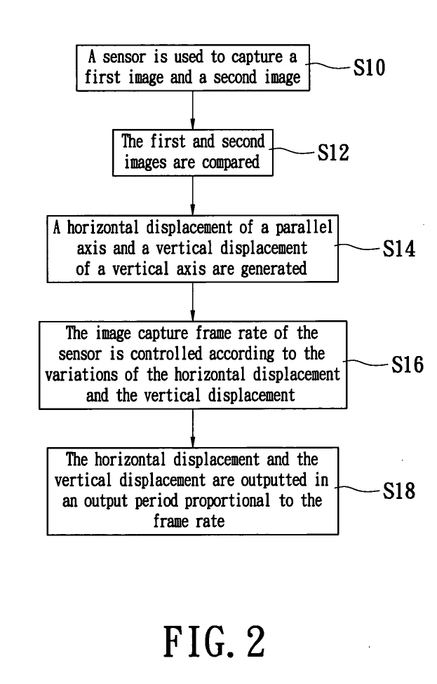

As shown in FIG. 2, a power-saving method for an optical navigation device according to a preferred embodiment of the present invention comprises mainly the following steps:
Step S10: A sensor is used to capture a first image and a second image;
Step S12: The first and second images are compared;
Step S14: A horizontal displacement of a parallel axis (x-axis) and a vertical displacement of a vertical axis (y-axis) are generated;
Step S16: The image capture frame rate of the sensor is controlled according to the variations of the horizontal displacement and the vertical displacement; and
Step S18: The horizontal displacement and the vertical displacement are outputted in an output period proportional to the frame rate.

In Step S10, the first image is the image captured before the optical navigation device, while the second image is the image captured after the predefined frame rate. A digital signal processor is used to compare the first and second images to obtain the relative horizontal and vertical displacements Δx and Δy. When the variations of the horizontal displacement and vertical displacement Δx and Δy are larger than an upper threshold, the image capture frame rate of the sensor is increased. When the variations of the horizontal displacement and vertical displacement Δx and Δy are smaller than a lower threshold, the image capture frame rate of the sensor is decreased. When the variations of the horizontal displacement and vertical displacement Δx and Δy are smaller than the upper threshold and larger than the lower threshold, the image capture frame rate of the sensor is kept. The image capture frame rate of the sensor is controlled according to different speeds of the optical navigation device to save power. In the prior art, no matter what the moving speed of the optical navigation device is, the image capture frame rate of the sensor is a fixed value.

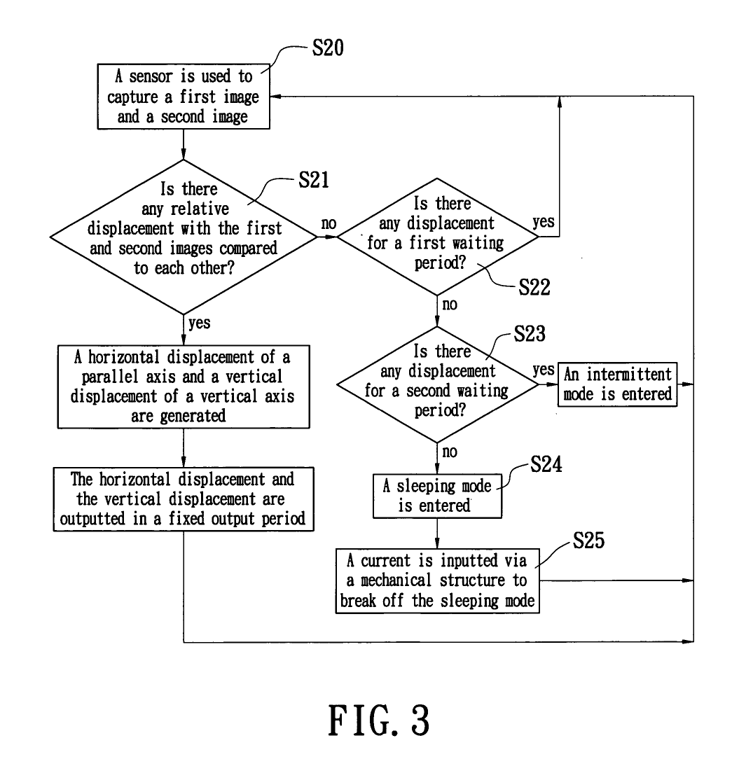

Moreover, as shown in FIG. 3, another power-saving method for an optical navigation device according to another preferred embodiment of the present invention comprises mainly the following steps:
Step S20: A sensor is used to capture a first image and a second image.
Step S21: The first and second images are compared to determine whether they are equal to each other;
Step S22: A first waiting period is lasted;
Step S23: A second waiting period is lasted;
Step S24: A sleeping mode is entered;
Step S25: A current is inputted via a mechanical structure to break off the sleeping mode; and
Step S26: The sensor starts to capture an image.

In Steps S22 and S23, if the first image is equal to the second image, it represents that the optical navigation device hasn't moved. In the first waiting period, the sensor will be driven periodically to capture images, and a digital signal processor will be used to calculate whether the optical navigation device moves or not. If the optical navigation device hasn't moved yet, the second waiting period will be entered. In the second waiting period, the sensor will be driven periodically with a longer period to capture images, and the digital signal processor will be used to calculate whether the optical navigation device moves or not. Generally speaking, because the optical navigation device will enter an intermittent mode in the second period, the period of driving the sensor to capture images in the second waiting period will be larger than that of driving the sensor to capture images in the first waiting period. If the optical navigation device is still in the static state in the second waiting period, the sleeping mode will be entered (Step S24). At this time, there will be no instruction to drive the sensor to capture images, hence wasting no power.

In the present invention, the optical navigation device will completely enter the sleeping mode. It is not necessary to drive the sensor to capture images every a fixed time, hence accomplishing the power-saving object. The present invention makes use of a displacement detector to detect the state of the optical navigation device in the sleeping mode. Therefore, when the user moves the optical navigation device again, a current will be inputted to break off the sleeping mode and drive the sensor to directly capture images (Step S25).

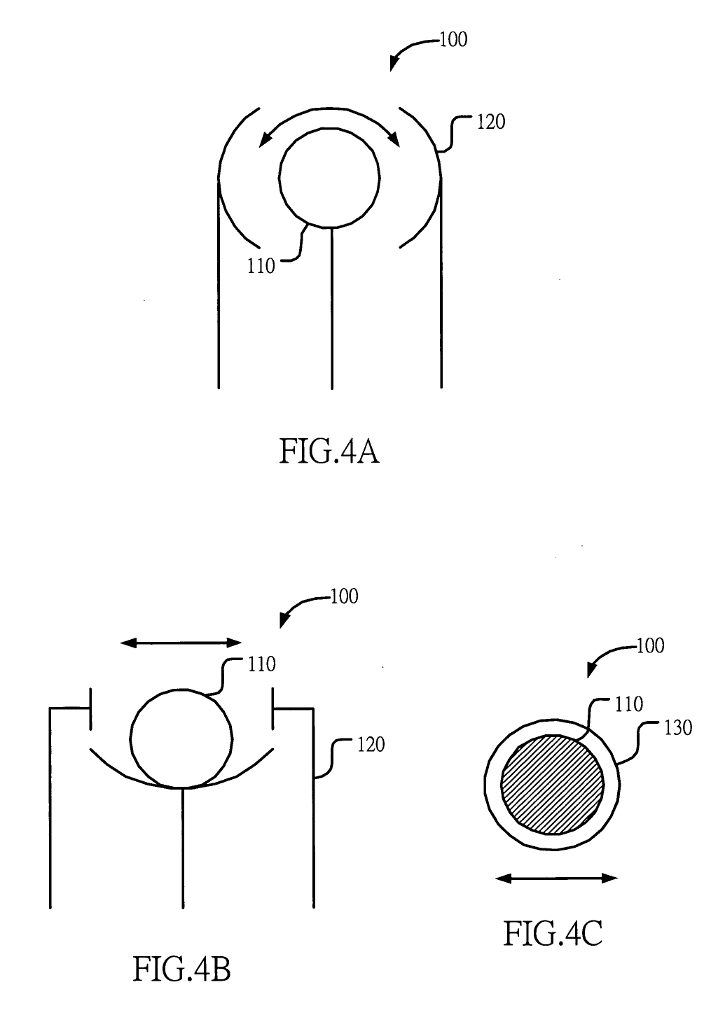

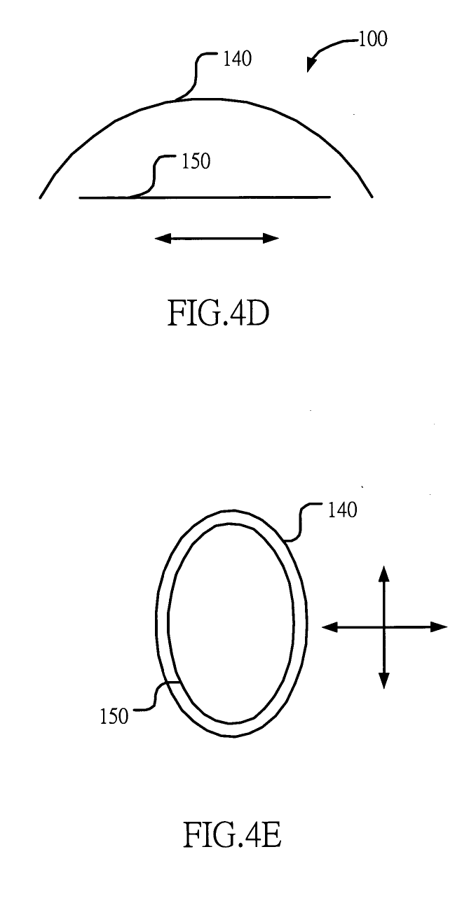

Finally, FIGS. 4A, 4B, 4C, 4D and 4E show diagrams of mechanical structures for interrupting the sleeping mode according to a preferred embodiment of the present invention. As shown in FIGS. 4A and 4B, a metal ball 110 of a mechanical structure 100 will collide with a contact point 120 near by to generate a current for driving the sensor to capture images when the user moves the optical navigation device. As shown in FIG. 4C, when the user moves the optical navigation device, a metal ball 110 will collide with a rim 130 to generate a current. As shown in FIG. 4D, an upper cover body 140 will contact a lower cover body 150 to generate a current when the user moves the optical navigation device. As shown in FIG. 4E, through a float design, the upper cover body 140 will contact the lower cover body 150 to generate a current when the user moves the optical navigation device. These structures are too numerous to enumerate. All structures making use of the displacement detector to accomplish a wakening function belong to the scope of the present invention.

The present invention will be illustrated in detail with the following example:

$$Optical resolution \text{:} 800 dpi ( dot per inch )$$

$$Maximum moving speed \text{:} 12 ips ( inch per sec )$$

$$\begin{matrix}Maximum Δ x or Δ y = 800 dpi \times 12 ips \\ = 9600 dot per sec \\ = 9.6 dot per ms\end{matrix}$$

| Frame | Moving speed | | | | | | | | |
|---|---|---|---|---|---|---|---|---|---|
| rate | 1 | 2 | 4 | 6 | 8 | 10 | 12 | 15 | 20 |
| 500 | 1.6 | 3.2 | 6.4 | 9.6 | 12.8 | 16 | 19.2 | 24 | 32 |
| 1000 | 0.8 | 1.6 | 3.2 | 4.8 | 6.4 | 8 | 9.6 | 12 | 16 |
| 1500 | 0.53 | 1.1 | 2.13 | 3.2 | 4.3 | 5.3 | 6.4 | 8 | 10.6 |
| 2000 | 0.4 | 0.8 | 1.6 | 2.4 | 3.2 | 4 | 4.8 | 6 | 8 |
| 3000 | 0.26 | 0.53 | 1.06 | 1.6 | 2.13 | 2.6 | 3.2 | 4 | 5.3 |
| 5000 | 0.16 | 0.32 | 0.64 | 0.96 | 1.28 | 1.6 | 1.9 | 2.4 | 3.2 |
| 10000 | 0.08 | 0.16 | 0.32 | 0.48 | 0.64 | 0.8 | 0.96 | 1.2 | 1.6 |

For instance, if Δx, Δy/F<2, the frame rate will be decreased. If Δx, Δy/F>8, the frame rate will be increased.

From the above table, the relative displacement of Δx and Δy will vary according to the moving speed and the frame rate. Therefore, the optimum frame rate can be set from the Δx and Δy value.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A power-saving method for an optical navigation device comprising the steps of:
using a sensor to capture a first image and a second image;
comparing said first image and said second image;
generating a horizontal displacement of a parallel axis and a vertical displacement of a vertical axis;
controlling the image capture frame rate of said sensor according to the variations of said horizontal displacement and said vertical displacement; and
outputting said horizontal displacement and said vertical displacement in an output period.

2. The power-saving method for an optical navigation device as claimed in claim 1, wherein said first image is the image captured by said sensor when said optical navigation device hasn't moved yet.

3. The power-saving method for an optical navigation device as claimed in claim 1, wherein said first and second images are compared by a digital signal processor, a central processing unit or a controller.

4. The power-saving method for an optical navigation device as claimed in claim 1, wherein the image capture frame rate of said sensor is increased when the variations of said horizontal displacement and said vertical displacement are larger than an upper threshold.

5. The power-saving method for an optical navigation device as claimed in claim 1, wherein the image capture frame rate of said sensor is decreased when the variations of said horizontal displacement and said vertical displacement are smaller than a lower threshold.

6. The power-saving method for an optical navigation device as claimed in claim 1, wherein the image capture frame rate of said sensor is maintained when the variations of said horizontal displacement and said vertical displacement are larger than a lower threshold and smaller than an upper threshold.

7. The power-saving method for an optical navigation device as claimed in claim 1, wherein said second image is the image captured by said sensor after a predefined frame rate.

8. The power-saving method for an optical navigation device as claimed in claim 7, wherein said frame rate is proportional to said output period.

9. A power-saving method for an optical navigation device, said method accomplishing the power-saving object through a displacement sensor, said method comprising the steps of:
using a sensor to capture a first image and a second image;
comparing said first image and said second image to make sure there is no displacement as long as said first image is equal to said second image;
lasting for a first waiting period; or
lasting for a second waiting period; or
entering a sleeping mode;
inputting a current via said displacement sensor to break off said sleeping mode; and
starting to capture images with said sensor.

10. The power-saving method for an optical navigation device as claimed in claim 9, wherein said sensor won't be driven to detect whether said optical navigation device moves or not during said sleeping mode.

11. The power-saving method for an optical navigation device as claimed in claim 9, wherein said displacement sensor can be a mechanical structure, a semiconductor micro-electro-mechanical (MEMS) structure, an assembly of the above two structures, or any structure capable of detecting displacement.
